(19) United States
(12) Patent Application Publication
(10) Pub. No.: US 2002/0018668 A1
(43) Pub. Date: Feb. 14, 2002

(54) Toner seal member, development cartridge, process cartridge and electrophotographic image forming apparatus

(76) Inventors: Kazuhiko Kanno, Odawara-shi (JP); Tatsuya Shiratori, Yokohama-shi (JP); Kouji Hashimoto, Shizuoka-ken (JP); Tachio Kawai, Odawara-shi (JP)

Correspondence Address: FITZPATRICK CELLA HARPER & SCINTO, 30 ROCKEFELLER PLAZA, NEW YORK, NY, 10112, US

(21) Appl. No.: 09/888,604

(22) Filed: Jun. 26, 2001

(30) Foreign Application Priority Data
Jun. 26, 2000 (JP) 190857/2000

(51) Int. Cl. G03G 15/08

(52) U.S. Cl. 399/106; 399/262

(57) ABSTRACT

A toner sealing member to be used for sealing a developer container including a developer accommodating portion for accommodating a developer; and an opening for supplying the developer from the developer accommodating portion, the toner seal member being for sealing the opening, wherein the toner seal member unseals the opening by being automatically wound up when the developer container, the toner seal member including a sealing portion for covering and sealing the opening; a regulating portion for regulation an operation of a detecting member for detecting winding-up of the toner seal member to unseal the opening.

### FIELD OF THE INVENTION AND RELATED ART

The present invention relates to a toner seal member, a developing cartridge, a process cartridge, and an alectrophotographic image forming apparatus to which said process cartridge is detachably mountable. The electrophotographic image forming apparatus forms an image on a recording material through an electrophotographic image formation type process. Examples of the electrophotographic image forming apparatus include an electrophotographic copying machine, an electrophotographic printer (a laser beam printer or LED printer mountable), a facsimile machine, a word processor and the like. The process cartridge integrally contains an electrophotographic photosensitive drum, and charging means, developing means or cartridge, in the form of a unit or a cartridge, which is detachably mountable to a main assembly of an image forming apparatus. The process cartridge may contain the electrophotographic photosensitive drum, and at least one of charging means, developing means and cleaning means, in the form of a cartridge which is detachably mountable to the main assembly of the image forming apparatus. Furthermore, the process cartridge may contain at least the electrophotographic photosensitive drum and the developing means. The present invention is applicable to a process cartridge having developing means of a such a structure.

Heretofore, in an electrophotographic image forming apparatus using the electrophotographic image process, a process cartridge type in which the electrophotographic photosensitive member and process means actable on the electrophotographic photosensitive member are integrally contained in a cartridge, which is detachably mountable to the main assembly of the image forming apparatus. Heretofore, in an electrophotographic image forming apparatus using the electrophotographic image process, a process cartridge type in which the electrophotographic photosensitive member and process means actable on the electrophotographic photosensitive member are integrally contained in a cartridge, which is detachably mountable to the main assembly of the image forming apparatus.

Such a process cartridge contains a photosensitive drum, and developing means is used to apply the developer (toner) to the latent image formed on photosensitive drum. In the developing means, a developing device frame supporting a developing roller for feeding the toner to the photosensitive drum and a toner frame (toner container) accommodating the toner, are coupled with each other. Before the start of use of the process cartridge, the opening provided in the connecting portion between the toner frame and the developing device frame are sealed by a seal member. A process cartridge equipped with an automatic toner seal removing device for automatically unsealing the opening of the toner frame when the process cartridge is mounted to the main assembly of the image forming apparatus, and an image forming apparatus which is capable of driving the automatic toner seal winding device, are known. In addition, a developing cartridge is also known which is integrally provided with developing means and a toner container accommodating the toner to be supplied to the developing means, in which an opening through which the toner is supplied to the developing means from the toner container is sealed. A developing cartridge provided with and automatic toner seal removing device.

The present invention provides a further development of such devices.

### SUMMARY OF THE INVENTION

Accordingly, it is a principal object of the present invention to provide a toner seal member, a developing cartridge, a process cartridge and an electrophotographic image forming apparatus in which a toner seal can be automatically wound up. It is another object of the present invention to provide a toner seal member, a developing cartridge, a process cartridge and an electrophotographic image forming apparatus in which the toner seal can be smoothly wound up.

It is a further object of the present invention to provide a toner seal member for accomplishing an automatic toner seal removing device in which the winding-up of the toner sealing member is assuredly detected for, and the driving of the winding shaft is finally stopped by which the outermost part of the wound-up toner seal flaps and/or the excessive load in the driving source can be avoided, but also to provide a development cartridge and a process cartridge on which the toner seal is removably affixed, and an electrophotographic image forming apparatus to which said process cartridge is detachably mountable.

According to an aspect of the present invention, there is provided a toner sealing member to be used for sealing a developer container including a developer accommodating portion for accommodating a developer; and an opening for supplying the developer from the developer accommodating portion, the toner seal member being for sealing the opening, wherein said toner seal member unseals the opening by being automatically wound up when said developer container, said toner seal member including a sealing portion for covering and sealing said opening; a regulating portion for regulation an operation of a detecting member for detecting winding-up of said toner seal member to unseal the opening.

According to another aspect of the present invention, there is provided a development cartridge and a process cartridge using the toner seal, and an image forming apparatus with which the toner seal, the development cartridge and the process cartridge are usable.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of a main assembly about image forming apparatus including a developing cartridge, according to the present invention.

FIG. 2 is a front view of a rotary unit used in the embodiment of the present invention.

FIG. 3 is a front view of the rotary unit used in the embodiment of the present invention.

FIG. 4 is a sectional view of the developing cartridge used in this embodiment.

FIG. 5 FIG. 4 is a sectional view of a developing cartridge used in this embodiment.

FIG. 6 is a perspective view of a developing cartridge according to an embodiment of the present invention.

FIG. 7 a perspective view of a developing cartridge according to an embodiment of the present invention.

FIG. 8 is an exploded perspective view of a developing cartridge according to an embodiment of the present invention.

FIG. 9 is an exploded perspective view illustrating a toner seal structure according to an embodiment of the present invention.

FIG. 10 is an exploded perspective view illustrating a toner seal structure according to an embodiment of the present invention.

FIG. 11 is a front view of an automatic unsealing mechanism of a toner seal member according to an embodiment of the present invention.

FIG. 12 is a front view of an automatic unsealing mechanism of a toner seal member according to an embodiment of the present invention.

FIG. 13 is a front view of a teeth missing type clutch mechanism according to an embodiment of the present invention.

FIG. 14 is a front view of a teeth missing type clutch mechanism according to an embodiment of the present invention.

FIG. 15 is a perspective view of a toner seal member winding-up detection structure according to an embodiment of the present invention.

FIG. 16 is a perspective view of a toner seal member winding-up detection structure according to an embodiment of the present invention.

FIG. 17 is a front view of a driving blocking mechanism according to an embodiment of the present invention.

FIG. 18 is a front view of a driving blocking mechanism according to an embodiment of the present invention.

FIG. 19 is a front view of a driving blocking mechanism according to an embodiment of the present invention

FIG. 20 is a perspective view are a toner seal member winding-up detection structure according to a further embodiment of the present invention.

FIG. 21 is a perspective view of a toner seal winding-up detection structure according to a further embodiment of the present invention.

### DESCRIPTION OF THE PREFERRED EMBODIMENTS

Next, an embodiment of a development cartridge in accordance with the present invention, and an electrophotographic image forming apparatus which employs such a development cartridge, will be described.

Embodiment 1

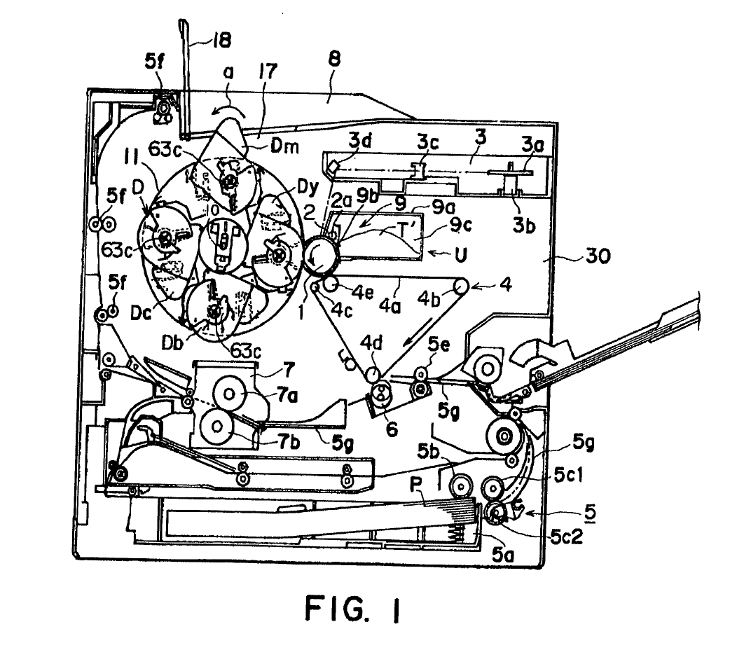

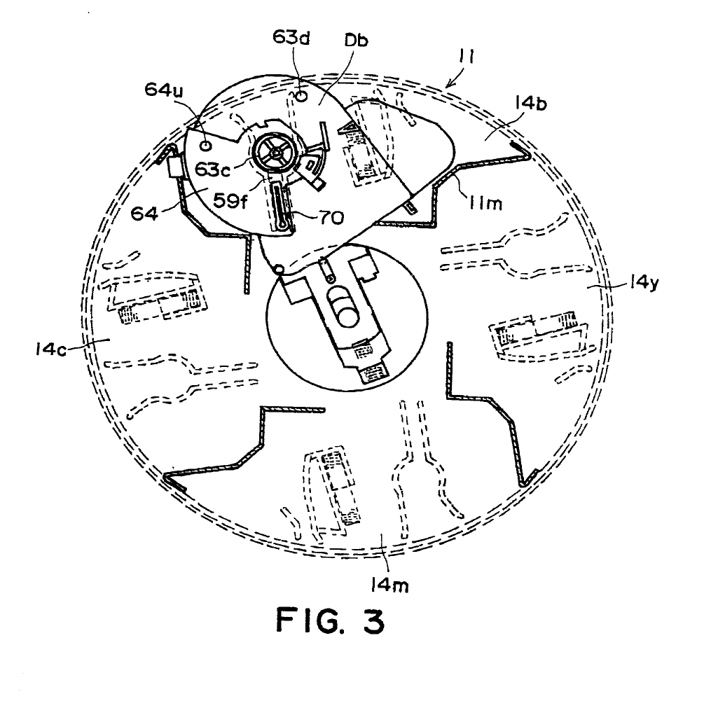

First, referring to FIGS. 1-14, the general structure of an image forming apparatus in accordance with the present invention will be described.

[General Description of Image Forming Apparatus]

First, referring to FIG. 1, the general structure of a color image forming apparatus will be described.

FIG. 1 is a vertical sectional view of a laser printer, a form of a color image forming apparatus, for describing the general structure thereof.

The color laser printer comprises: a process cartridge U in which a photosensitive drum 1, which rotates at a constant velocity, is supported; an image forming portion comprising four rotatable development cartridge D; and an intermediary transfer member 4 which holds color images as the color images are developed in the image forming portion and transferred onto the intermediary transfer member 4, and then transfers the color images onto a transfer medium P delivered to the intermediary transfer member 4 by a conveying means 5.

The transfer medium P onto which the color images have been just transferred is conveyed to a fixing portion, in which the color images are fixed to the transfer medium P. Thereafter, the transfer medium P is discharged by a discharge roller 5f into a delivery portion 8 located at the top of the apparatus. The rotatable development cartridges D are structured so that they can be individually mounted into or dismounted from the main assembly 30 of the printer.

Next, the structures of various components and portions of the image forming apparatus will be described detail.

[Process Cartridge]

The process cartridge U has a photosensitive drum 1, and a cleaning apparatus, the container portion 9a of which is an integral part of the process cartridge U and doubles as the holder for the photosensitive drum 1. It is removably supported by the printer main assembly 30 so that the process cartridge U which is currently in the printer main assembly 30 can be easily replaced with a new process cartridge in accordance with the service life of the photosensitive drum 1.

The photosensitive drum 1 in this embodiment comprises an aluminum cylinder with a diameter of approximately 50 mm, and an organic photoconductor layer coated on the peripheral surface of the aluminum cylinder. It is rotationally supported by the cleaning apparatus container portion 9a which doubles as the holder for photosensitive drum 1. In the adjacencies of the peripheral surface of the photosensitive drum 1, a cleaning blade 9b for removing the developer (toner) remaining on the peripheral surface of the photosensitive drum 1, and a primary charging means 2 for uniformly charging the peripheral surface of the photosensitive drum 1, are disposed. The photosensitive drum 1 is rotated in the counterclockwise direction, as shown in the drawing, in synchronism with an image forming operation, by transmitting driving force from an unshown motor to one end of the photosensitive drum 1, that is, the end on the rear side of the drawing.

[Charging Means]

The charging means 2 in this embodiment is such as charging means that employs a contact charging method, and comprises an electrically conductive roller 2a, which is placed in contact with the photosensitive drum 1. The peripheral surface of the photosensitive drum 1 is uniformly charged by applying voltage to the charge roller 2a placed in contact with the peripheral surface of the photosensitive drum 1.

[Exposing Means]

The exposing of the photosensitive drum 1 is carried out by a scanner portion 3. More specifically, as image signals are given to a laser diode, the laser diode emits image light modulated with the image signals, at a polygon mirror 3a.

The polygon mirror 3a is rotated at a high velocity by a scanner motor 3b. While the polygon mirror 3a is rotated at a high velocity, the image light is reflected by the polygon mirror 3a, passed through a focusing lens 3c, deflected by a reflection mirror 3d, and projected onto the peripheral surface of the photosensitive drum 1 which is being rotated at a predetermined constant velocity, selectively exposing the peripheral surface of the photosensitive drum 1. As a result, an electrostatic latent image is formed on the peripheral surface of the photosensitive drum 1.

[Developing Means]

The developing means is provided with four development cartridge Dy, Dm, Dc and Db, which are capable of visualizing, that is, developing, an electrostatic latent image in yellow, magenta, cyan, and black colors, correspondingly.

Referring to FIGS. 1-3, each of the four development cartridges D is removably held by a rotary unit 11 enabled to rotate about a shaft 10. In an image forming operation, each development cartridge D is moved by the rotation of rotary unit 11 to a predetermined position, at which the development roller, which will be described later, opposes the photosensitive drum 1, holding a microscopic gap (approximately 300 μm) from the photosensitive drum 1, and forms a visible image which reflects the electrostatic latent image, on the photosensitive drum 1.

In a color image forming operation, each time the intermediary transfer member 4 rotates once, the rotary unit 11 also rotates once, moving the yellow development cartridge Dy, magenta development cartridge Dm, cyan development cartridge Dc, and black development cartridge Db, in this order, to the above described predetermined position to carry out development processes.

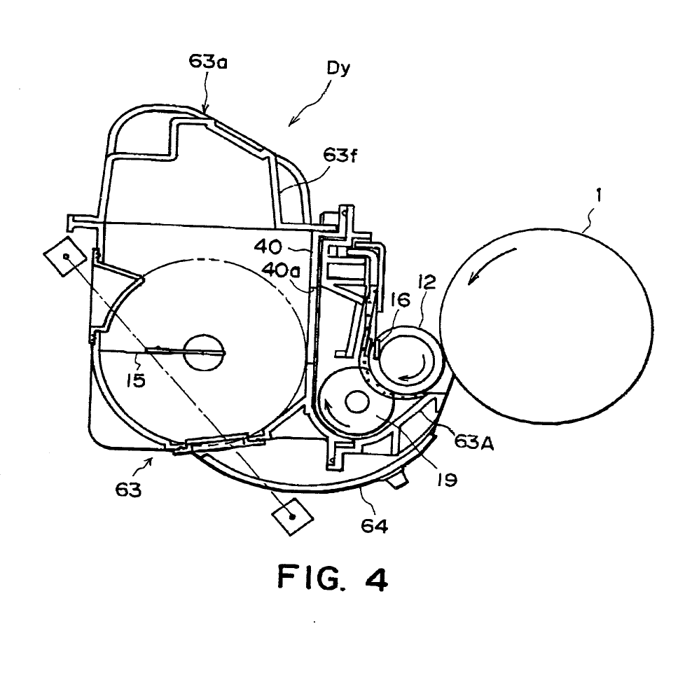

FIG. 4 shows the yellow development cartridge Dy which is standing sill, being positioned to oppose the process cartridge U. In the development cartridge Dy, the toner in the toner container 63a is sent to a toner supplying roller 19 by a toner sending mechanism 15. Then, the toner is coated in a thin layer on the peripheral surface of the development roller 12, which is rotating in the clockwise direction indicated in the drawing, by the toner supplying roller 19 which is rotating in the clockwise direction indicated also in the drawing, and a development blade 16 which is kept pressed upon the peripheral surface of the development roller 12. While the toner is coated, the toner is given electrical charge (triboelectrical charge).

Then, development bias is applied to the development roller 12, which is opposing the photosensitive drum 1 on which a latent image has been formed, to form a toner image which reflects the latent image on the photosensitive drum 1. The same toner image forming process as the one described above with reference to the yellow development cartridge Dy is also carried out in the magenta development cartridge Dm, cyan development cartridge Dn, and black development cartridge Db, which are the same in mechanism as the yellow development cartridge Dy described above.

The image forming apparatus main assembly 30 is structured so that, as each development cartridge D is rotated to the development position, its development roller 12 is connected to a high voltage power source and a mechanical driving means (unshown), and development bias is applied to the development roller 12. This process is carried out one after another for all development cartridges in the aforementioned order.

The yellow, magenta, and cyan development cartridges Dy, Dm and Dc, shown in FIG. 4, are the same in structure; they each have the toner supplying roller 19, which is rotationally supported by the developing means holding portion 63A of the cartridge frame 63. The peripheral surface of the toner supplying roller 19 moves in the direction opposite to the direction in which the peripheral surface of the development roller 12 moves.

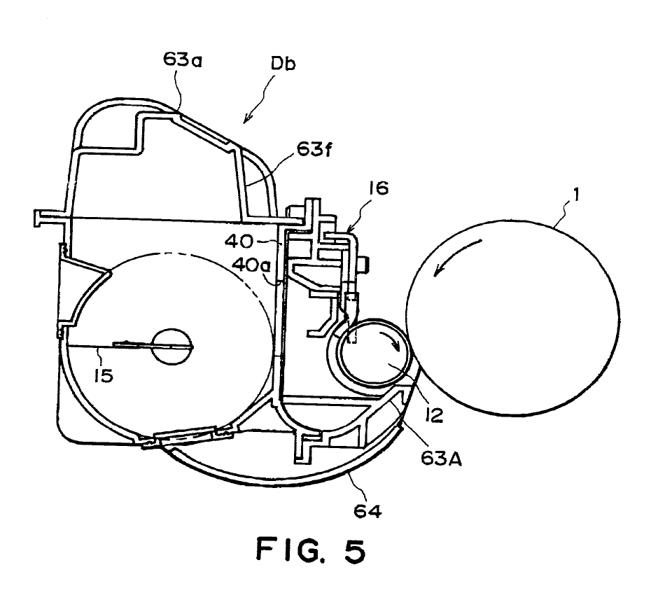

In comparison, the black development cartridge Db shown in FIG. 5 does not have the toner supplying roller 19; toner is adhered to the development roller 12 by magnetic force, or adheres to the development roller 12 due its own adhesive force, and the thickness of the toner layer on the development roller 12 is required by the development blade 16 placed in contact with the peripheral surface of the development roller 12. As the toner layer on the peripheral surface of the development roller 12 is regulated in thickness, the toner is given triboelectrical charge.

[Cleaning Means]

The intermediary transfer member 4 is a member onto which a toner image is temporarily transferred. More specifically, each time one full-color image is formed, four toner images different in color (Y, M, C and Bk color images), or four visible images different in color, formed on the photosensitive drum 1 by the four developing means, one for one, are transferred in layers onto the intermediary transfer member 4, which is being rotated in the clockwise direction indicated in the drawing, at the same peripheral velocity as that of the photosensitive drum 1. The intermediary transfer member 4 having received a plurality toner images, in layers, transfers, all at once in layers, the color toner images thereon onto the transfer medium P by conveying the transfer medium P by sandwiching the transfer medium P between itself and the transfer roller 6 to which voltage is being applied. In the intermediary transfer member 4 in this embodiment, an endless transfer belt 4a formed of dielectric material is stretched around a driver roller 4b, a follower roller 4c, a secondary transfer counter roller 4d, and a primary transfer roller 4e. The primary transfer roller 4e is positioned in a manner to sandwich the transfer belt 4a between itself and the photosensitive drum 1.

[Cleaning Means]

The cleaning means 9 is a means for removing, from the photosensitive drum 1, the toner remaining on the photosensitive drum 1 after the toner image, or a visual image, formed on the photosensitive drum 1 by the developing means is transferred by the intermediary transfer member 4. The toner removed from the photosensitive drum 1, or residual toner T is collected in a residual toner container 9a. The amount of the residual toner is not large enough to fill up the residual toner container 9a before the service life of the photosensitive drum 1 expires. Thus, the residual toner container 9a, which is a part of the process cartridge U, is replaced with a new one, at the same time as the process cartridge U is replaced with a new one due to the expiration of the service life of the photosensitive drum 1.

[Sheet Feeding Portion]

The conveying means 5, the most upstream portion of which in terms of the recording medium conveyance direction is a sheet feeder portion, is a means for conveying the transfer medium P to the image forming portion. It essentially comprises: a cassette 5a in which a plurality of transfer media P are stored; a sheet feeder roller 5b, a combination of a sheet feeder roller 5c1 and a retarder roller for preventing the recording medium P from being fed by two or more, a sheet guide 5g, and a registration roller 5e.

In an image forming operation, the sheet feeder roller 5b is rotationally driven in synchronism with the image forming operation to feed the recording media P within the cassette 5a into the apparatus main assembly, one by one. Then, each recording medium P is conveyed, while being guided by guiding plates (unshown), to the registration roller 5e past the sheet feeder roller 5c1.

During the image forming operation, the registration roller 5e carries out, in a predetermined sequence, a process in which it remains still to keep the transfer medium P on standby, and a process in which it rotates to release and convey the recording medium P toward the intermediary transfer member 4, so that the released transfer medium P aligns with an image during the following process, that is, the transfer process.

[Transferring Portion]

The transferring portion comprises the transfer roller 6, which can be moved in the direction to be pressed upon the transfer belt 4a, or in the direction to be separated therefrom. The transfer roller 6 comprises a metallic shaft, and a layer of foamed elastic material wrapped around the peripheral surface of the metallic shaft. The electrical resistance of the foamed elastic material layer is in the medium range. It is movable in the vertical direction of the drawing, and is connected to a mechanical driving means.

While the above mentioned four toner images are formed on the intermediary transfer member 4, that is, while the intermediary transfer member 4 rotates a plural number of times, the transfer roller 6 is kept at the bottom position outlined by a bold line in the drawing, being kept away from the intermediary transfer member 4, to prevent the transfer roller 6 from disturbing the images while they are being formed.

Then, as the formation of the four toner images different in color on the intermediary transfer member 4 ends, the transfer roller 6 is moved to the top position outlined by a fine line in the drawing, by an unshown cam, in synchronism with the timing with which the multi-color image, or the combination of the four color toner images, is to be transferred onto the transfer medium P. In other words, the transfer roller 6 is pressed upon the intermediary transfer member 4, with the interposition of the transfer medium P between the intermediary transfer member 4 and transfer roller 6. At the same time as the transfer roller 6 is pressed upon the intermediary transfer member 4, bias begins to be applied to the transfer roller 6. As a result, the toner images on the intermediary transfer member 4 are transferred onto the transfer medium P.

The intermediary transfer member 4 and transfer roller 6 are driven independently from each other. Therefore, as the transfer process progresses, the transfer medium P being sandwiched between the two rollers is conveyed leftward of the drawing at a predetermined velocity to the fixing portion 7, in which the following process is carried out.

[Fixing Portion]

The fixing portion 7 is a portion for fixing the toner images, which have been formed on the photosensitive drum 1 by developing means and have been transferred onto the transfer medium P, to the transfer medium P. It comprises: a fixing roller 7a for applying heat to the transfer medium P, and a pressure roller 7b for pressing the transfer medium P upon the fixing roller 7a. Both rollers 7a and 7b are hollow and contain a heater. They are rotationally driven and convey together the transfer medium P.

More specifically, as the transfer medium P, which is holding the toner images, is conveyed by the fixing roller 7a and pressure roller 7b, heat and pressured is applied to the recording medium P and toner images thereon. As a result, the toner images are fixed to the transfer medium P.

[Mounting of Development Cartridge into Image Forming Apparatus Main Assembly]

Next, how the development cartridge is mounted will be described.

First, an unshown button of the printer main assembly 30 is pressed. As the button is pressed, the rotary unit 11 rotates until a specific development cartridge mounting slot of the rotary unit 11, the color designation of which matches the color of the development cartridge D the user wished to mount, comes to a predetermined position at which the development cartridge D can be mounted. In other words, the rotary unit 11 stops there, when one of the development cartridge mounting slots 14y, 14m, 14c and 14b, which each occupy one quarter of the development rotary 11, aligns with the development cartridge mounting opening 17.

Next, the user opens the cover 18 of the development cartridge mounting opening 17 located at a predetermined portion of the printer main assembly 30. Normally, the opening 17 is kept covered with the cover 18.

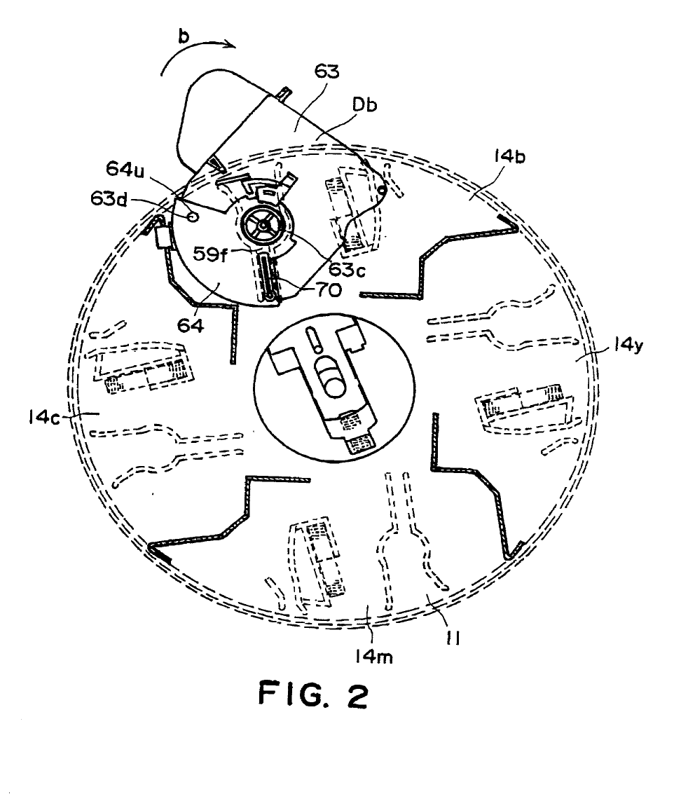

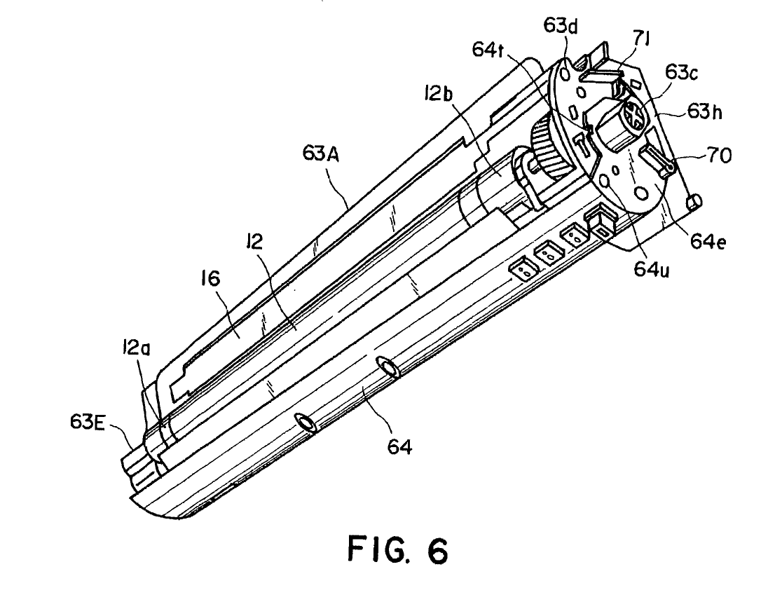

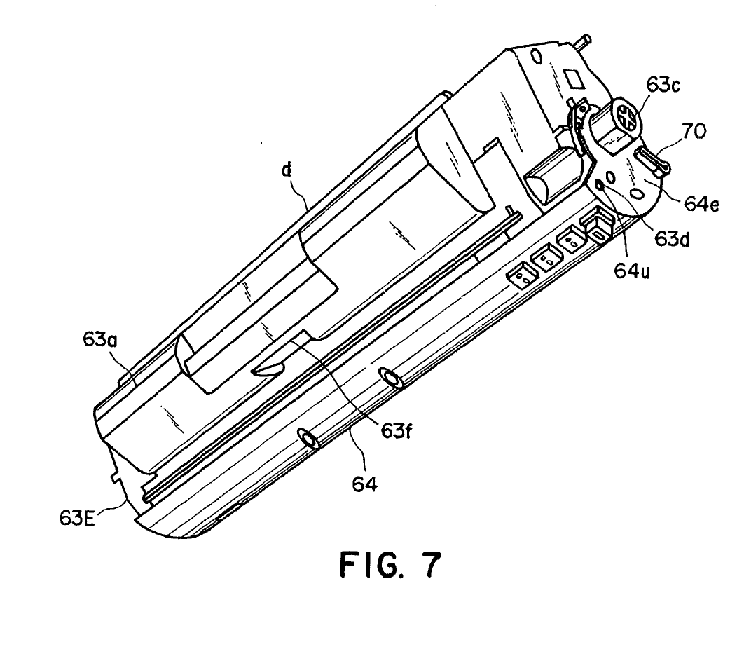

Then, the guide ribs 70 (FIG. 6) on the side walls of the shutter 64 (which will be described later in detail) of the development cartridge D identical in color to the color designation of the development cartridge mounting slot 14 which is at this point aligning with the opening 17, is rested on the cartridge guides 59f on the internal walls of the rotary unit 11 of the apparatus main assembly 30, and the development cartridge D is pushed inward (FIG. 2). At this point, the operator grasps by hand the handhold recess 63f (FIG. 7) integral with the toner container portion 63a of the development cartridge D, and turns the development cartridge D in the direction indicated by an arrow mark (1) in FIG. 1. As the development cartridge D is turned, only the actual development unit D rotates, with the shutter remaining held to the rotary unit 11. As a result, the development roller 12 is exposed, to be ready for development (FIG. 5).

[Shutter]

Next, referring to FIGS. 6-8, the shutter 64 of the development cartridge D will be described.

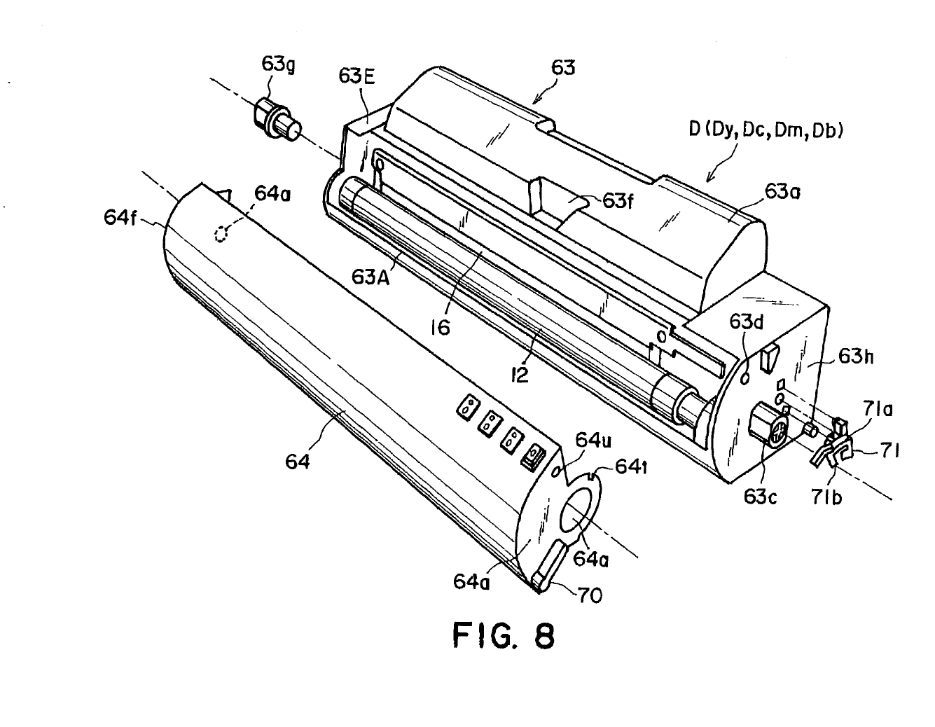

Referring to FIG. 8, both side walls 64e and 64f of the shutter 64 in terms of the lengthwise direction of the shutter 64 are provided with a round hole 64a, into which the projections 63c and 63g projecting, one for one, from the side walls of the developing means holding frame 63 in terms of its lengthwise direction, are fitted to rotationally support the shutter 64 by the cartridge frame 63. Next, referring to FIGS. 6 and 7, the shutter 64 is enabled to take the covering position at which it covers the development roller 12, or the retracted position at which it exposes the development roller 12. When the development cartridge D is out of the printer main assembly 30, the shutter 64 remains closed. Therefore, when the development cartridge D has never been used, it does not occur that dust and the like adheres to the development roller 12, or the development roller 12 is damaged.

The cartridge frame 63 is provided with a locking member 71 for keeping the shutter 64 locked in the closed state, which is on one of the side walls 63e, in the adjacencies of the projection 63c. The locking member 71 comprises an elastic arm portion 71a and an engaging portion 71b. On the other hand, one of the side walls 64e of the shutter 64, on the same side as the locking member 71, is provided with a recess 64t, which is located at a predetermined position, and with which the engaging portion 71b engages. Thus, when the shutter 64 is in the closed state, the engaging portion 71b remains engaged in the recess 64t, keeping the shutter 64 locked in the closed state to prevent the shutter 64 from accidentally opening.

As the development cartridge D is inserted into the printer main assembly 30, the lock is automatically released to allow the shutter 64 to be opened.

Further, the side walls 64e of the shutter 64 are provided with a round hole 64u, and the side walls 63h of the development unit are provided with a semispherical projection 63d, the position of which corresponds to that of the round hole 64u. Thus, when the shutter 64 is in the closed state, the semispherical projections 63d remain engaged in the corresponding round holes 64u, and therefore, even after the shutter 64 is unlocked as described above, the positional relationship between the shutter 64 and development cartridge D in terms of the rotational direction of the shutter 64 does not become unstable.

[Automatic Toner Seal Opening Apparatus]

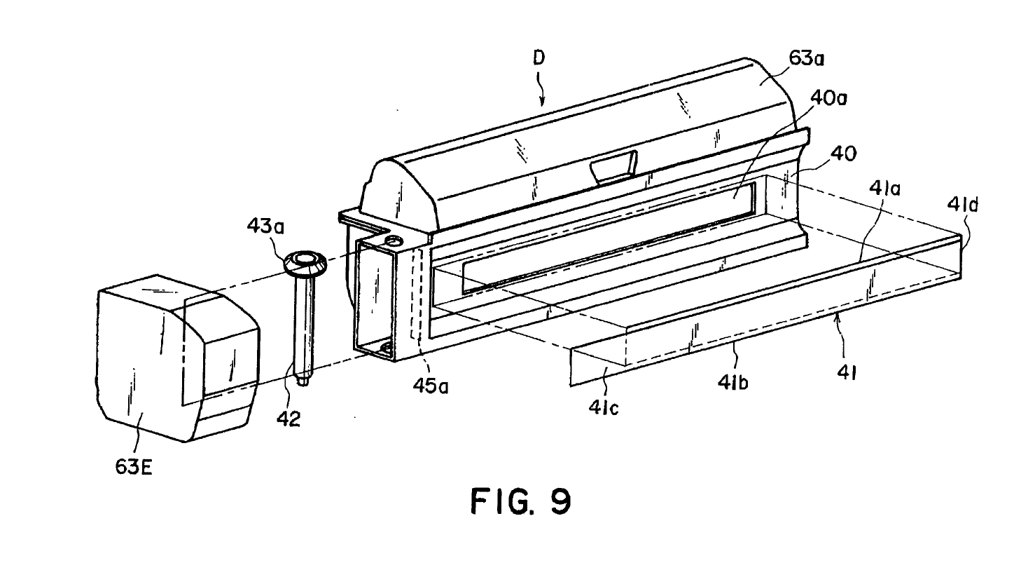

Next, referring to FIGS. 9-19, the structure of an embodiment of an automatic mechanism for opening a toner seal, in accordance with the present invention, will be described in detail.

In the automatic toner seal opening mechanism, which will be described below, a toner sealing member 41 is provided with a regulating portion 41e for regulating a detection level for detecting the winding of the toner sealing member 41, and the toner sealing member 41 is kept pressed upon the regulating portion 41e. The completion of the winding of the toner sealing member 41 is detected as the detection lever 82b is automatically moved as the winding of the toner sealing member 41 is completed.

The transmission of driving force to a winding shaft 42 is automatically stopped by a stopping member as the detection lever 82b is allowed to move, by the completion of the winding of the toner sealing member 41.

The provision of the above described mechanism, in which the toner sealing member is given the function for regulating the detecting means for detecting the completion of the winding of the toner sealing member, and the transmission of driving force to the winding shaft is automatically stopped as the completion of the winding of the toner sealing member is detected, assures that the completion of the winding of the toner sealing member is accurately detected. As a result, the scattering of toner and/or generation of strange noises, which is caused by the flapping of the toner seal, does not occur. Further, the load exerted upon the motor is reduced.

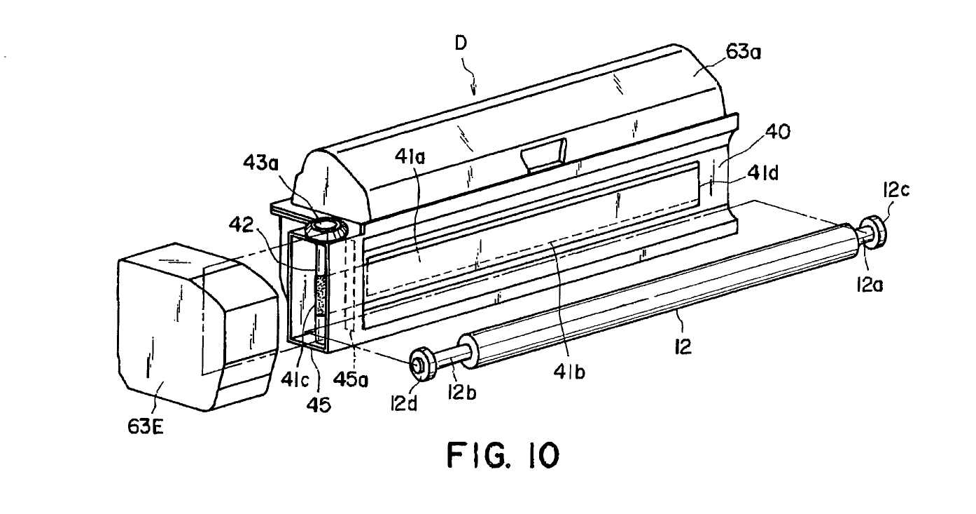

The frame of the development cartridge D comprises a toner container portion 63a in which toner is stored, and a developing means holding portion 63A. Referring to FIG. 9, the wall 40 of the toner container portion 63a, on the developing means holding portion 63A side, is provided with a toner supplying opening 40a, along the fringe of which the toner sealing member 41 is peelably pasted with the use of thermal welding or the like, to keep the toner sealed within the toner container portion 63a to prevent the toner from scattering while the development cartridge D is delivered to a user, that is, during the transportation of the development cartridge D. In this embodiment, the toner sealing member 41 is formed of flexible sheet. FIGS. 9 and 10 show the structure of toner sealing means in accordance with the present invention. The length of the toner sealing member 41 is more than twice the measurement of the aforementioned opening 40a in terms of the lengthwise direction of the opening 40a. The toner sealing member 41 comprises: a sealing portion 41a peelably attached to the fringe of the opening 40a in a manner to seal the opening 40a by such a means as thermal welding, and a doubling portion 41b which is continuous with one end of the sealing portion 41b. The doubling portion 41b is folded back at a double back point 41b in the adjacencies of the end of the opening 41a, in terms of its length direction, at which the two portions are continuous. It is doubled back on the sealing portion 41a, to the other end of the opening 41a. The end portion 41c of the doubling portion 41b, which is not continuous with the sealing portion 41a, is fixed to a winding shaft 42 with the use of adhesive or the like. The winding shaft 42 is enabled to be rotated about a rotational axis perpendicular to the axial line of the development roller 12, being rotationally supported by the toner container portion 63a. One end of the winding shaft 42 is provided with a first bevel gear 43a for rotating the winding shaft 42, which is an integral part of the winding shaft 42.

Referring to FIG. 10, the flange 12b of the development roller 12, on the winding shaft 42 side, is provided with the development roller gear B12d, which is firmly fixed thereto, and is used for transmitting the driving force inputted from the printer main assembly (image forming apparatus main assembly), which will be described later, to the winding shaft 42. The development roller gear B12d and winding shaft 42 are connected to each other through a gear train provided on the side holder 63E, which will be described later. The side holder 63E is attached to one end of the toner container portion 63a in terms of the lengthwise direction.

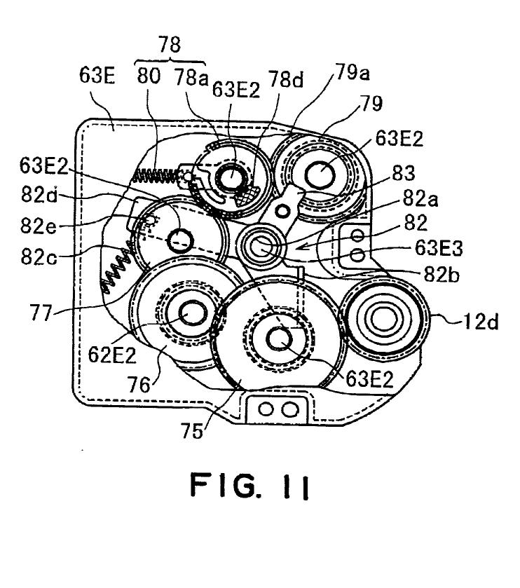

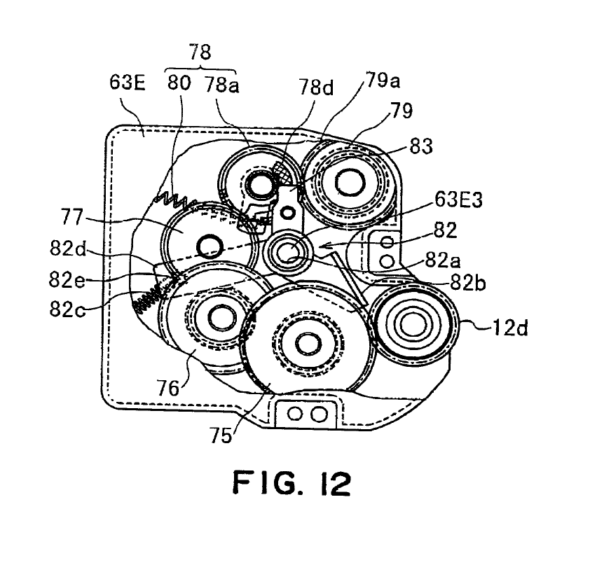

Next, referring to FIGS. 11 and 12, the positions of the gears of the gear train mounted on the side holder 63E for transmitting driving force from the image forming apparatus main assembly 30 will be described. FIGS. 11 and 12 show the state of the gear train before and after the toner sealing member 41 is wound, respectively. On the plurality of shafts 63E2 with which the side holder 63E is provided, idler gears A75, B76 and C77, a partially teeth missing gear 74a, and a second bevel gear 79, are rotationally supported, one for one. More specifically, to list the gears rotationally supported by the side holder 63E from the upstream side in terms of the direction in which driving force inputted from the image forming apparatus main assembly 30 is transmitted to the winding shaft, the first one is the idler gear A75 meshed with the development roller gear B12d, and the second gear is the idler gear B76 for reducing the revolution of the development roller gear B12, at which the development roller 12 is driven, to a predetermined revolution. The next gear is the idler gear C77 The idler gears A75 and B76 are step gears, and in order to transmit driving force, the smaller diameter portion of the idler gear A75 is meshed with the large diameter portion of the idler gear B76, whereas the smaller diameter portion of the idler gear B76 is meshed with the idler gear C77. The idler gear C77 is meshed with the partially teeth missing gear 78a, which is meshed with the second bevel gear 79, which is meshed with the first bevel gear 43a integral with the winding shaft 42. The driving force inputted from the image forming apparatus main assembly 30 is transmitted to the winding shaft 42 through the above described gear train. The second bevel gear 79 has a gear 79a integral with the second bevel gear 79. The gear 79a is a spur gear and is meshed with the partially teeth missing gear 78a.

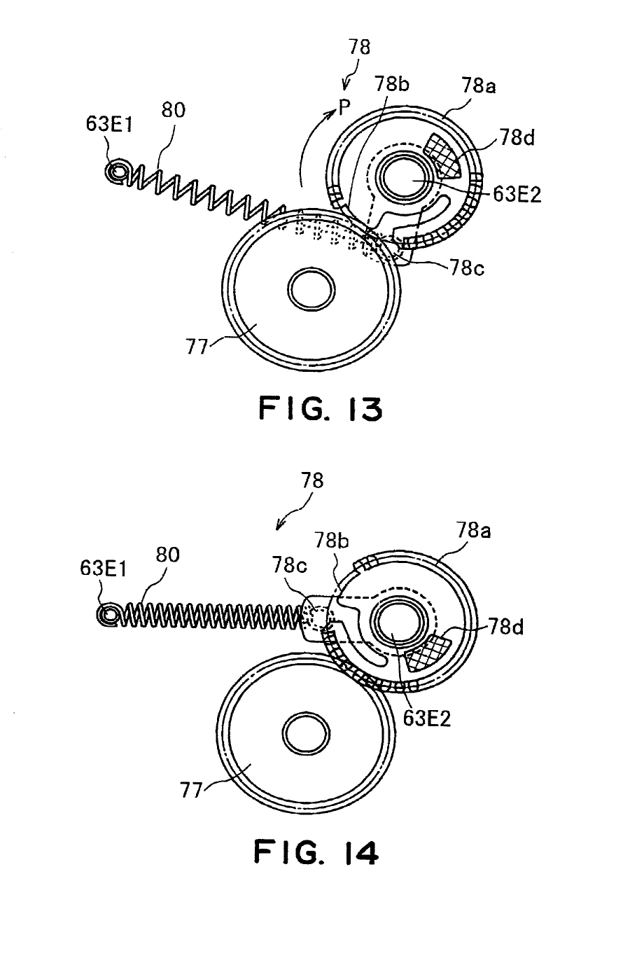

Referring to FIG. 13, a clutch 78 comprises the partially teeth missing gear 78a (1/10-⅕ of the entire teeth are missing), which has a portion 78b across which the teeth are missing, and a spring 80. One end of the spring 80 is hung on a shaft 78c located at the end of the arm portion on the inwardly facing surface of the partially teeth missing gear 78a in terms of the lengthwise direction of the development cartridge D, keeping the partially teeth missing gear 78a under rotational force. The other end of the spring 80 is hung on a spring hanger 63E1 of the side holder 63F. The spring 80 is a tension coil spring. Referring to FIG. 13, as driving force is inputted, the meshing between the idler gear C77 and partially teeth missing gear 78b is temporarily nullified while the teeth missing portion 78b of the partially teeth missing gear 78a is opposing the idler gear C77. As the meshing is nullified, that is, the two gears become disengaged, the partially teeth missing gear 78a, which is under the rotational force (directed as indicated by arrow mark P in FIG. 13) from the spring 80, rotates until it meshes again with the idler gear C77 as shown in FIG. 14. This sequence of disengaging and engaging occurs once for each full turning of the partially teeth missing gear 78a. More specifically, before the toner sealing member 41 is wound, the partially teeth missing clutch 78 and idler gear C77 remain engaged as shown in FIG. 11. The outwardly facing surface of the partially teeth missing gear 78a in terms of the lengthwise direction is provided with a projection 78d. The projection 78d is an integral part of the partially teeth missing gear 78a.

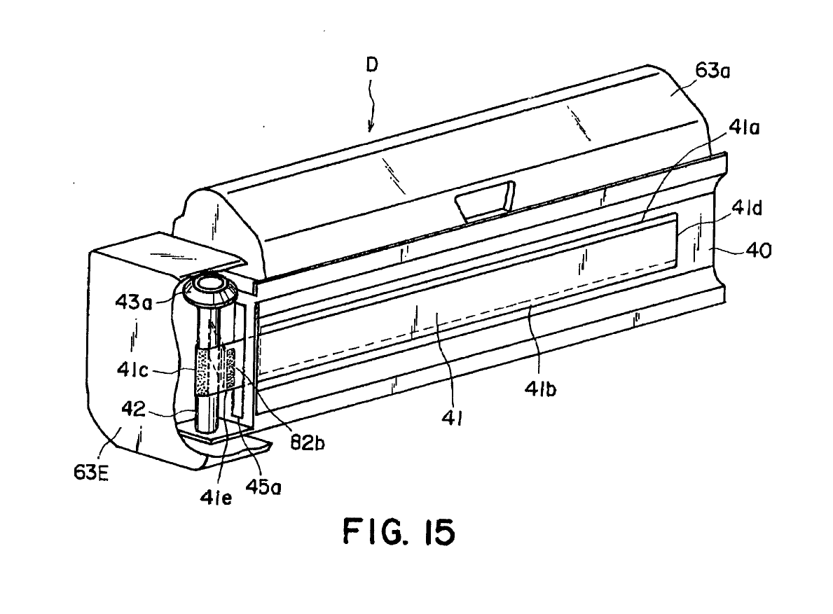

Further, the side holder 63E is provided with a detecting means for detecting the completion of the winding of the toner sealing member 41, and a stopper 83 which is for stopping the transmission of driving force to the winding shaft 42, and moves in coordination with the detecting means 82. The detecting means 82 is rotationally supported by a shaft 63E3 with which the side holder 63E is provided; the shaft 63E is put through the hole 82a of the detecting means 82. The detecting means 82 comprises the detection lever 82b as a detecting member, which is extended in the radial direction of the shaft 63E and is kept pressed upon the regulating portion 41e (FIG. 15) of the doubling portion 41b of the toner sealing member 41, by the pressure generated by a spring 83c. Further, the aforementioned stopper 83, which is an integral part of the detecting means 83, is moved to be placed in contact with the projection 78d of the clutch 78, by the detection lever 82b of the detecting means 82 in response to the detection of the completion of the winding of the toner sealing member 41. One end of the aforementioned spring 82c is hung on the spring hanger 82e, an integral part of the arm 82d, located at the end of the arm 82d, and the other end is anchored to the side holder 63E. The spring 82c is a tension spring.

Referring to FIG. 10, in this embodiment, the winding shaft 42 is covered with a winding shaft cover 45, which is an integral part of the toner container portion 63a, or is formed independently from the toner container portion 63a and is fixed to the toner container portion 63a by welding or the like. The winding shaft cover 45 is provided with a slit 45a through which the toner sealing member 41 is put; the end of the doubling portion 41c is put through the slit 45a and is fixed to the winding shaft 42.

Next, the movement of the automatic toner sealing member opening mechanism structured as described above will be concretely described.

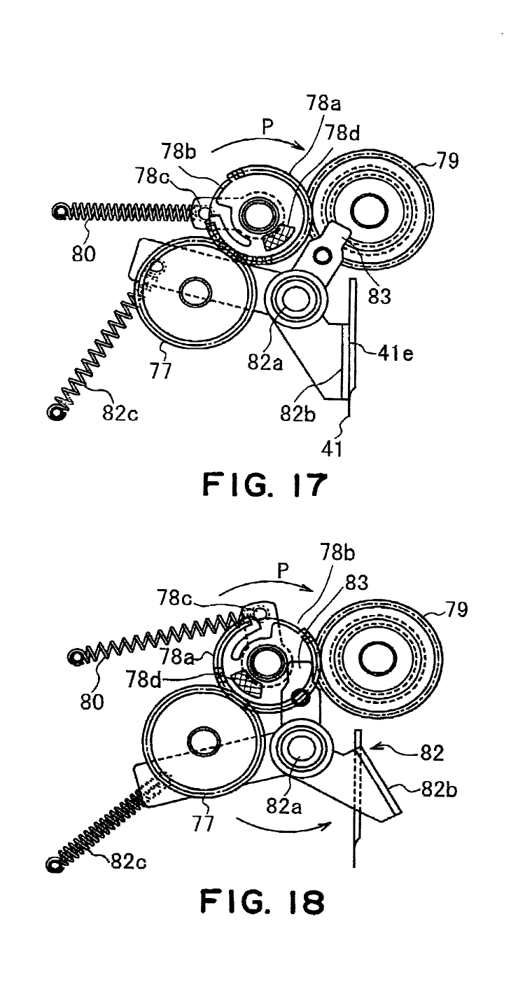

Referring to FIG. 15, before the toner sealing member 41 is wound, the detection lever 82b of the detecting means 82 is in contact with the regulating portion of the doubling portion 41b of the toner sealing member 41, being prevented from moving. In this state, the stopper 83 is away from the position at which it contacts the projection 73d of the clutch 78 (see FIG. 17). As the development cartridge D in this state is mounted in the image forming apparatus main assembly 30, driving force is inputted to a driving force input gear (unshown) located at the opposite end of the development cartridge, with respect to the winding shaft 42. Referring to FIG. 10, this driving force input gear is meshed with a development roller gear A12c attached to a flange 12a of the development roller 12, and rotationally drives the development roller 12; the flange 12a is located on the opposite side of the development roller 12 with respect to the winding shaft 42 in terms of the lengthwise direction. Thus, driving force is transmitted to the winding gear 42 through the aforementioned gear trains comprising the development roller gear B12d, idler gears A75, B76 and C77, partially teeth missing 78a, gear 79a, second bevel gear 79, and first bevel gear 74a, to rotate the winding shaft 42.

As is evident from the above description, the toner sealing member 41, which has been airtightly sealing the opening 40a as shown in FIG. 10, is wound around the winding shaft 42. As the toner sealing member 41 is completely wound up by the winding shaft 42, the opening 40a becomes fully open, allowing toner to be supplied to the development roller 12.

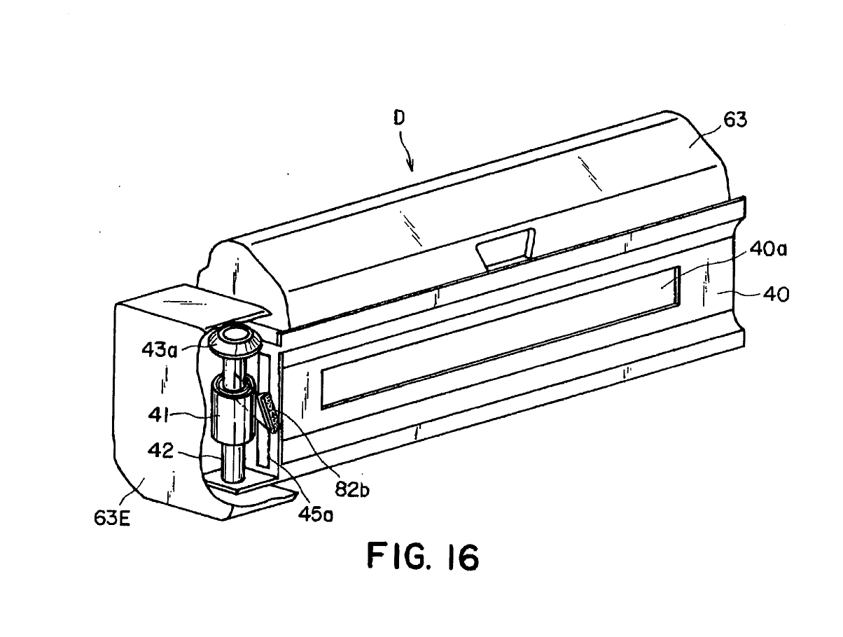

Next, referring to FIG. 16, as the toner sealing member 41 is completely wound up by the winding shaft 42, the regulating portion 41e of the toner sealing member 41 is also wound away. In other words, the regulating portion 41e, which has been preventing the detection lever 82b of the detecting means 82 from moving, is removed. As a result, the detection lever 82b is allowed to rotate about the axial line of the hole 82a, in the direction in which it is pressured by the spring 82c; in other words, the completion of the winding of the toner sealing member 41 is detected. Also as the completion of the winding of the toner sealing member 41 is detected, the stopper 83 comes into contact with the projection 78d of the clutch 78, preventing driving force from being transmitted to the winding shaft 42.

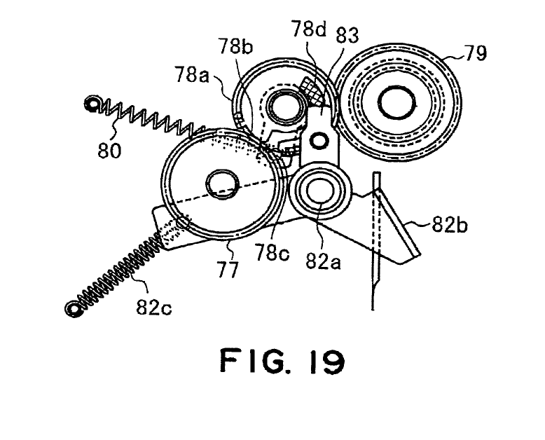

At this time, the driving force transmission stopping mechanism of the clutch 78 will be described in detail. FIG. 18 shows the state in which the detecting means 82 has detected the completion of the winding of the toner sealing member 41, and the stopper 83 has moved to the point at which it can come into contact with the projection 78d of the clutch 78. In this state, the idler gear C77 and partially teeth missing gear 78a are still meshed with each other, and the projection 78d has not reached the point at which it comes into contact with the stopper 83: in other words, the transmission of driving force to the winding shaft 42 has not been stopped. Then, as the clutch 78 is rotated further by receiving driving force from the idler gear C77, the teeth missing portion 78b of the partially teeth missing gear 78a comes into the range in which it opposes the idler gear C77, causing the two gears to disengage from each other, as shown in FIG. 19. As the two gears disengage, the rotational force from the spring 80, under which the partially teeth missing gear 78a is kept, works on the partially teeth missing gear 78a in the direction to rotate the gear 78a in reverse to make the gear 78a reengage with the idler gear C77. However, the projection 78d comes into contact with the stopper 83 before the reengagement occurs, and therefore, the partially teeth missing gear 78a is not allowed to reengage with the idler gear C77. Therefore, the transmission of driving force does not occur any more As the transmission of driving force to the partially teeth missing gear 78a stops, the transmission of driving force to the second bevel gear 79 and first bevel gear 43a also stops. Therefore, it does not occur that driving force is transmitted to the winding shaft 42 for the second time. Thus, it does not occur that driving force is transmitted to the winding shaft 42 after the completion of the winding of the toner sealing member 41 In other words, it does not occur that driving force is unnecessarily transmitted to the winding shaft 42. Therefore, the flapping of the end portion of the toner sealing member 41 and/or touching of the end portion of the toner sealing member 41 on the adjacencies, which causes the scattering of toner, generation of strange noises, and the like problems, do not occur. Further, the load exerted upon the motor of the image forming apparatus main assembly 30 after the completion of the winding of the toner sealing member 41 is smaller.

In this embodiment, the transmission of driving force to the winding shaft 42, the axial direction of which is different from that of the gear from which it receives driving force, is accomplished with the use of a bevel gear. However, the application of the present invention is not limited to this structural arrangement. For example, the transmission of driving force to the winding shaft 42 different in axial direction from the gear from which it receives driving force may be accomplished with the use of a worm gear or the like. Further, the detection lever, as a detecting member, of the detecting means, which elastically contacts the regulating portion 41e of the toner sealing member, may be replaced with a rod which makes direct movement. In such a case, the rod is provided with a stopper which can be engaged with or disengaged from the projection 78d of the partially teeth missing gear 78a.

Also in this embodiment, the structure of the image forming apparatus is such that the process cartridge and development cartridge are independent from each other, and can be separately mounted into or dismounted from the apparatus main assembly. However, the application of the present invention is not limited to such a structural arrangement. For example, the structure of the image forming apparatus may be such that a process cartridge comprising the developing means is removably mounted in the apparatus main assembly, or that the apparatus main assembly is provided with a built-in toner hopper which can be replenished with toner with the use of a toner cartridge.

Embodiment 2

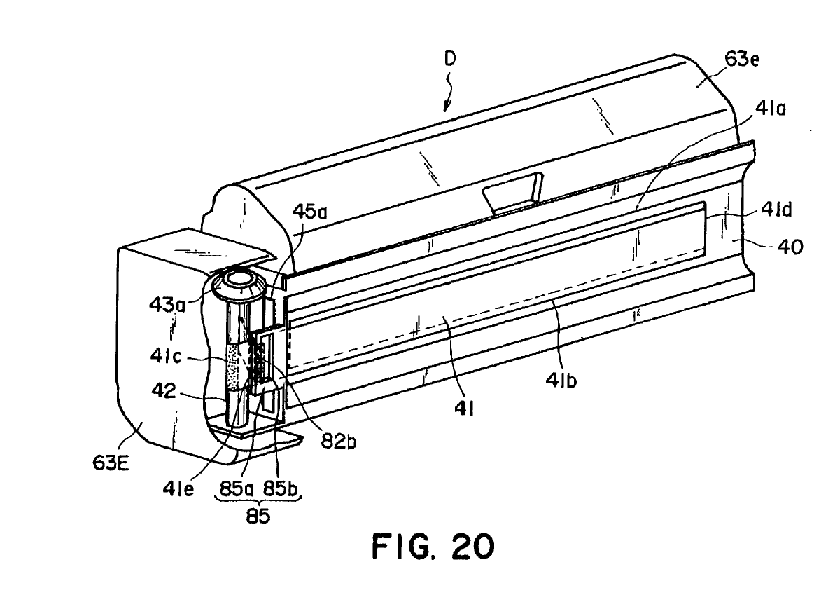

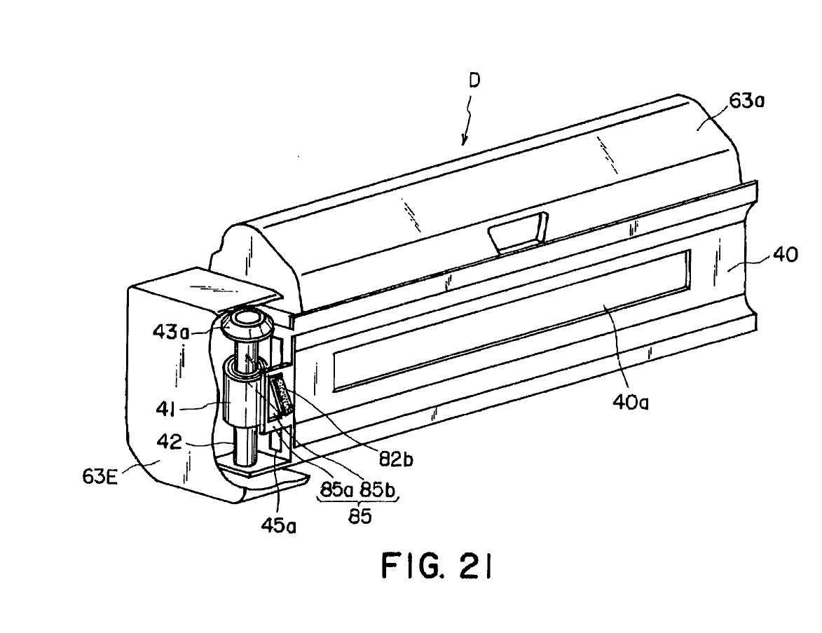

Next, referring to FIGS. 20 and 21, the second embodiment of the present invention will be described.

Incidentally, the components and portions in this embodiment, which are the same in structure and function as those in the first embodiment, will be given the same referential codes, so that the descriptions given regarding the first embodiment can be quoted.

In the above described first embodiment, the detection lever 82b for detecting the completion of the winding of the toner sealing member 41 is kept pressed upon the regulating portion 41e of the doubling portion 41b of the toner sealing member 41, by the pressure from the spring 82c, so that as the regulating portion 41e, which is preventing the rotational movement of the detection level 82b, is wound away as the toner sealing member 41 is completely wound up by the winding shaft 42, the detecting level 82b is allowed to be rotated by the pressure from the spring 82c; in other words, the completion of the winding of the toner sealing member 41 is detected.

In comparison, referring to FIGS. 20 and 21 in this second embodiment of the present invention, the toner container portion 63a is provided with a backup member 85, which is formed as an integral part of the toner container portion 63a, and is located on the back side of the regulating portion 41e of the toner sealing member 41 upon which the detection lever 82b is kept pressed by the resiliency of the spring 82c. The backup member 85 is provided with a surface 85a, the plane of which virtually coincides with that of the peelably pasted toner sealing member 41. The backup member 85 is provided with a hole 85b, into which the detection lever 82b moves as the winding of the toner sealing member 41 is completed.

Also in this embodiment, before the toner sealing member 41 is wound away, the detection lever 82b is in contact with the regulation portion 41e of the doubling portion 41b of the toner sealing member 41, being therefore prevented from moving (see FIG. 19). However, as the toner sealing member 41 is completely wound away by the winding shaft 42, the regulating portion 41e, that is, the portion which prevents the movement of the detection member 82b, is also wound away. As a result, the detection lever 82b rotates through the hole 85b of the backup member 85 in the direction in which the pressure is exerted upon the detection lever 82b by the spring 82c; in other words, the completion of the winding of the toner sealing member 41 is detected (FIG. 21), as is in the first embodiment. The provision of the backup member 85 which supports the regulating portion 41e from behind, by the surface 85a eliminates the problem that the toner sealing member 41 in the form of a flexible sheet is indented by the rigid detection lever 82b kept pressed upon the toner sealing member 41, assuring that the completion of the winding of the toner sealing member 41 is accurately detected. Further, more latitude is afforded for the amount of the pressure applied by the spring 82c, selection of the material for the toner sealing member, and the like.

As is evident from the above descriptions, according to the present invention a toner sealing member, which is pasted to the fringe of the developer supplying opening of a developer container to airtightly seal the opening, and is automatically wound away as a developer container, or a cartridge which has a developer container, is mounted into the image forming apparatus main assembly to expose the developer supplying opening, is provided with a sealing portion for covering the opening to airtightly seal the opening, and a regulating portion for regulating the movement of the detection member for detecting that the toner sealing member has been completely wound away to expose the opening.

Further, a development cartridge, or a process cartridge which has an electrophotographic photosensitive member, to which the aforementioned toner seal is peelably pasted, comprises: a developing means for developing a latent image formed on the electrophotographic photosensitive member; a developer container provided with an opening for supplying developer to the developing means; a winding shaft rotationally supported by the developer container for winding away the toner seal; a driving means for rotationally driving the winding shaft; a detecting member for detecting whether or not the toner seal has been completely wound away; and a driving force controlling means for preventing the driving means from rotationally driving the winding shaft, wherein as the completion of the winding of the toner seal is detected, driving force controlling means is automatically activated to stop the transmission of the rotational force from the driving means

According to an aspect of the above described structural arrangement, the toner sealing member is provided with the regulating portion upon which the detection member is kept pressed, so that as the winding of the toner sealing member is completed, the detection member is automatically moved to signal the completion of the winding of the toner sealing member, assuring that the completion of the winding of the toner sealing member is accurately detected. Further, the transmission of driving force to the winding shaft is automatically stopped as the completion of the winding of the toner sealing member is detected, and therefore, it does not occur that driving force is transmitted to the winding shaft after the completion of the winding of the toner sealing member; in other words, it does not occur that driving force is unnecessarily transmitted to the winding shaft. Consequently, the flapping of the end portion of the toner sealing member 41 and/or touching of the end portion of the toner sealing member 41 on the adjacencies, which causes the scattering of toner, generation of strange noises, and the like problems, do not occur Further, the load exerted upon the motor of the image forming apparatus main assembly 30 after the completion of the winding of the toner sealing member 41 is smaller.

While the invention has been described with reference to the structures disclosed herein, it is not confined to the details set forth and this application is intended to cover such modifications or changes as may come within the purposes of the improvements or the scope of the following claims.

What is claimed is:

1. A toner sealinq member to be used for sealing a developer container including a developer accommodating portion for accommodating a developer; and an opening for supplying the developer from the developer accommodating portion, the toner seal member being for sealing the opening, wherein said toner seal member unseals the opening by being automatically wound up when said developer container, said toner seal member comprising:
a sealing portion for covering and sealing said opening;
a regulating portion for regulation an operation of a detecting member for detecting winding-up of said toner seal member to unseal the opening.

2. A toner seal member according to claim 1, wherein said regulating portion includes a fold-back portion of an extension of said sealing portion.

3. A toner seal member according to claim 1 or 2, wherein said regulating portion regulates said detecting member between said developer container and a winding shaft to which an end of said fold-back portion is fixed.

4. A development cartridge which is detachably mountable a main assembly of an image forming apparatus, wherein a toner seal member is removably affixed thereto, said developing cartridge comprising:
a developing means for developing a latent image formed on an electrophotographic photosensitive member;
a developer container having an opening for supplying a developer to said developing means;
a toner seal member, affixed to seal said opening, for unsealing said opening by being automatically wound up when said development cartridge is mounted to the main assembly of said image forming apparatus, said toner seal member including a sealing portion for covering and sealing said opening and a regulating portion for regulation an operation of said detecting member for detecting winding-up of said toner seal member to unseal said opening;
a toner seal member winding shaft, rotatably supported on said developer container, for winding toner seal member up;
driving means for rotating said winding shaft;
detecting member for detecting whether toner seal member is wound up or not; and
driving control means for stopping rotational driving of said driving means in interrelation with said detecting member.

5. A development cartridge according to claim 4, wherein said driving means receivers a driving force from the main assembly of the image forming apparatus.

6. A development cartridge according to claim 4 or 5, wherein said detecting means is urged by a spring to be abutted to said toner seal member.

7. A development cartridge according to claim 4, 5 or 6, wherein said driving control means includes a stopper for stopping rotation of said driving means in interrelation with detection of substantially completion of winding-up of said toner seal member by said detecting member.

8. A process cartridge which is detachably mountable to a main assembly of an image forming apparatus, said process cartridge is sealed by a removable toner seal member, comprising:
an electrophotographic photosensitive member;
developing means for developing a latent image formed on said electrophotographic photosensitive member;
a developer container having an opening for supplying a developer to said developing means;
a toner seal member, affixed to seal said opening, for unsealing said opening by being automatically wound up when said process cartridge is mounted to the main assembly of said image forming apparatus, said toner seal member including a sealing portion for covering and sealing said opening and a regulating portion for regulation an operation of said detecting member for detecting winding-up of said toner seal member to unseal said opening;
a toner seal member winding shaft, rotatable supported on said developer container, for winding toner seal member up;
driving means for rotating said winding shaft;
detecting member for detecting whether toner seal member is wound up or not; and
a driving control means for stopping rotational drive of said driving means in interrelation with said detective member.

9. A process cartridge according to claim 8, wherein said driving means receives a driving force for driving an electrophotographic photosensitive drum from the main assembly of the image forming apparatus.

10. A process cartridge according to claim 8 or 9, wherein said detecting member is urged by a spring to be abutted to said regulating portion.

11. A process cartridge according to claim 8, 9 or 10, wherein said driving control means includes a stopper for stopping rotation of said driving means in interrelation with detection of substantial completion of winding-up of said toner seal member by said detecting member.

12. An electrophotographic image forming apparatus for forming an image on the recording material, to which a development cartridge is detachably mountable, said apparatus comprising:
a. A developing means for developing a latent image formed on an electrophotographic photosensitive member;
b. A mounting means for mounting a development cartridge, said development cartridge including,
a developer container having an opening for supplying a developer to said developing means;
a toner seal member, affixed to seal said opening, for unsealing said opening by being automatically wound up when said development cartridge is mounted to the main assembly of said image forming apparatus, said toner seal member including a sealing portion for covering and sealing said opening and a regulating portion for regulation an operation of said detecting member for detecting winding-up of said toner seal member to unseal said opening;
a toner seal member winding shaft, rotatably supported on said developer container, for winding toner seal member up;
driving means for rotating said winding shaft;
detecting member for detecting whether toner seal member is wound up or not; and
driving control means for stopping rotational driving of said driving means in interrelation with said detective member;
said apparatus further comprising:
b. Feeding means for feeding the recording material; and
c. Driving means for driving said development cartridge.

13. An electrophotographic image forming apparatus for forming an image on the recording material, to which a development cartridge is detachably mountable, said apparatus comprising;
a. An electrophotographic photosensitive member;
developing means for developing a latent image formed on said electrophotographic photosensitive member;
b. A mounting means for mounting a development cartridge, said development cartridge including,
a developer container having an opening for supplying a developer to said developing means;
a toner seal member, affixed to seal said opening, for unsealing said opening by being automatically wound up when said process cartridge cartridge is mounted to the main assembly of said image forming apparatus, said toner seal member including a sealing portion for covering and sealing said opening and a regulating portion for regulation an operation of said detecting member for detecting winding-up of said toner seal member to unseal said opening;
a toner seal member winding shaft, rotatably supported on said developer container, for winding toner seal member up;
driving means for rotating said winding shaft;
driving control means for stopping rotational driving of said driving means in interrelation with said detective member; driving control means for stopping rotational driving of said driving means in interrelation with said detective member; detecting member for detecting whether toner seal member is wound up or not; and
driving control means for stopping rotational driving of said driving means in interrelation with said detective member;
b. Feeding means for feeding the recording material; and
C. Driving means for driving said process cartridge. Winding-up.

14. A toner cartridge which is detachably mountable to a main assembly of an image forming apparatus, said process cartridge is sealed by a removable toner seal member, comprising:
a developer container having an opening for supplying a developer to developing means;
a toner seal member, affixed to seal said opening, for unsealing said opening by being automatically wound up when said toner cartridge is mounted to the main assembly of said image forming apparatus, said toner seal member including a sealing portion for covering and sealing said opening and a regulating portion for regulation an operation of said detecting member for detecting winding-up of said toner seal member to unseal said opening;
a toner seal member winding shaft, rotatably supported on said developer container, for winding toner seal member up;
driving means for rotating said winding shaft;
driving control means for stopping rotational driving of said driving means in interrelation with said detective member; driving control means for stopping rotational driving of said driving means in interrelation with said detective member; detecting member for detecting whether toner seal member is wound up or not; and
driving control means for stopping rotational drive of said driving means in interrelation with said detecting member.

15. A toner cartridge according to 14, wherein said driving means receives a driving force from a main assembly of an image forming apparatus.

16. A toner cartridge according to claim 14 or 15, wherein said detecting member is urged by a spring and is abutted to said regulating portion of said toner seal member.

17. A toner cartridge according to claim 14, 15 or 16, wherein said driving control means includes a stopper for stopping rotation of said driving means in interrelation with detection of substantial completion of winding-up of said toner seal member by said detecting member.
